(19) United States
(12) Patent Application Publication
(10) Pub. No.: US 2026/0296146 A1
(43) Pub. Date: Oct. 1, 2026

(54) SHADE APPARATUS FOR VEHICLES

(71) Applicant: AISIN CORPORATION, Kariya, Aichi (JP)

(72) Inventors: Daiki GOTO, Kariya-shi, Aichi-ken (JP); Takanori HATTORI, Kariya-shi, Aichi-ken (JP); Shota MOTOMURA, Kariya-shi, Aichi-ken (JP)

(73) Assignee: AISIN CORPORATION, Kariya, Aichi (JP)

(21) Appl. No.: 19/476,763

(22) PCT Filed: Jul. 1, 2024
(86) PCT No.: PCT/JP2024/023720

§ 371 Date: Oct. 20, 2025

(30) Foreign Application Priority Data
Jul. 5, 2023 (JP) 2023-110431

(51) Int. Cl. B60J 1/20; B60J 7/00

(52) U.S. Cl. CPC B60J 1/2052; B60J 1/2025; B60J 1/2075; B60J 7/0015

(57) ABSTRACT

A shade apparatus for vehicles includes paired shoes provided at corresponding side end portions of the shade, paired guide members extending in a longitudinal direction and each including a guide chamber opened on one side in a width direction, a string inserted into the guide chamber of each of the guide members and connected to a distal end portion of the shade, and a drive device that pulls the string to separate the distal end portion of the shade from the winding member, the side end portion of the shade is folded to an opening side of the guide chamber, each of the shoes includes an insertion portion to be inserted into a folded side end portion of the shade, and the folded side end portion of the shade and the insertion portion of each of the shoes are inserted into the guide chamber of each of the guide members and are slidably supported by each of the guide members. As a result, the shade apparatus for vehicles can be made compact in a height direction.

### CROSS-REFERENCE TO RELATED APPLICATIONS

This is a National Stage of International Application No. PCT/JP2024/023720 filed Jul. 1, 2024, claiming priority based on Japanese Patent Application No. 2023-110431 filed Jul. 5, 2023.

### TECHNICAL FIELD

The present disclosure relates to a shade apparatus for vehicles provided on a roof of a vehicle.

### BACKGROUND ART

Conventionally, there has been known a shade apparatus including paired rails, a shade housing portion disposed between one end portions of the paired rails, and a shade capable of shielding light (see, for example, Patent Literature 1). In this shade apparatus, a fixed bar (shade bar) is fixed to the distal end portion of the shade, and one drive block is connected to each end of the fixed bar. Each drive block is slidably fitted into the corresponding rail, and by moving each drive block along the rail via, for example, a geared cable or the like, the shade can be drawn from the shade housing portion and deployed. Each rail includes a bending guide portion that bends and passes the side edge of the shade, which is drawn from the shade housing portion and deployed, and a guide rail portion. The side edge of the shade drawn from the shade housing portion is bent by the bending guide portion, enters the guide rail portion, and is slidably supported by the rail.

Furthermore, conventionally, there has been known a sunshade drive device including a shade shaft, a sunshade, first and second cable drums arranged at both end portions of the shade shaft, a drive system cable, and a driven system cable (see, for example, Patent Literature 2). In this drive device, one end of the drive system cable is connected to the cable guide groove of the first cable drum so as to be windable and drawable, the other end thereof is connected to the terminal bar (shade bar) of the sunshade, and the intermediate portion thereof is connected to the drive drum. One end of the driven system cable is connected to the cable guide groove of the second cable drum so as to be windable and drawable, and the other end thereof is connected to the terminal bar. Further, both end portions of the terminal bar are inserted into guide rails integrally formed on both left and right frame portions of the peripheral frame portion of the roof panel, and are guided by the guide rails so as to be movable in the front-rear direction.

### CITATION LIST

### Patent Literature

Patent Literature 1: JP 2012-158324 A

Patent Literature 2: JP 2010-274693 A

### SUMMARY OF THE DISCLOSURE

### Technical Problems

However, in the rail of the shade apparatus described in Patent Literature 1, the guide space into which the drive block is fitted is provided above the guide rail portion that supports the side edge of the shade, independently of the guide rail portion. For this reason, in the conventional shade apparatus, it is difficult to reduce the dimension of the rail in the height direction, and mountability is degraded. Even in a case where the terminal bar is guided by the guide rail as in the drive device described in Patent Literature 2, the dimension of the guide rail in the height direction increases, and the mountability of the drive device is degraded.

Therefore, the present disclosure provides a shade apparatus for vehicles that can be made compact in a height direction.

### Solutions to Problems

A shade apparatus for vehicles of the present disclosure is a shade apparatus for vehicles that is provided on a roof of a vehicle, winds a shade around a winding member, and draws the shade from the winding member, the shade apparatus for vehicles including paired shoes provided at corresponding side end portions of the shade, paired guide members extending in a longitudinal direction and each including a guide chamber opened on one side in a width direction, a string inserted into the guide chamber of each of the guide members and connected to a distal end portion of the shade, and a drive device that pulls the string to separate the distal end portion of the shade from the winding member, the side end portion of the shade is folded to an opening side of the guide chamber, each of the shoes includes an insertion portion to be inserted into a folded side end portion of the shade, and the folded side end portion of the shade and the insertion portion of each of the shoes are inserted into the guide chamber of each of the guide members and are slidably supported by each of the guide members.

The shade apparatus for vehicles of the present disclosure includes the paired shoes provided at the corresponding side end portions of the shade, the paired guide members extending in the longitudinal direction and each including the guide chamber opened on one side in the width direction, the string inserted into the guide chamber of each of the guide members and connected to the distal end portion of the shade, and the drive device that pulls the string to separate the distal end portion of the shade from the winding member. The side end portion of the shade is folded to the opening side of the guide chamber, and each of the shoes includes the insertion portion to be inserted into the folded side end portion of the shade. The folded side end portion of the shade and the insertion portion of each of the shoes are inserted into the guide chamber of each of the guide members and are slidably supported by each of the guide members. In this manner, by inserting the insertion portion of each of the shoes into the folded side end portion of the shade, and inserting the insertion portion and the folded side end portion into the single guide chamber, the dimension of each of the guide members that slidably supports the shade and each of the shoes in the height direction can be reduced while the removal of the shade and each of the shoes from the guide chamber is successfully prevented. As a result, the shade apparatus for vehicles can be made compact in the height direction to improve the mountability of the shade apparatus for vehicles.

### BRIEF DESCRIPTION OF DRAWINGS

FIG. 1 is a perspective view illustrating the main part of a vehicle including a shade apparatus for vehicles of the present disclosure.

FIG. 2 is an exploded perspective view illustrating the shade apparatus for vehicles of the present disclosure.

FIG. 3 is an enlarged cross-sectional view illustrating the shade apparatus for vehicles of the present disclosure.

FIG. 4 is a schematic configuration diagram illustrating the shade apparatus for vehicles of the present disclosure.

FIG. 5 is a schematic configuration diagram illustrating the shade apparatus for vehicles of the present disclosure.

FIG. 6 is a schematic configuration diagram illustrating another shade apparatus for vehicles of the present disclosure.

FIG. 7 is a schematic configuration diagram illustrating another shade apparatus for vehicles of the present disclosure.

FIG. 8 is a schematic configuration diagram illustrating another shade apparatus for vehicles of the present disclosure.

FIG. 9 is a schematic configuration diagram illustrating still another shade apparatus for vehicles of the present disclosure.

FIG. 10 is a schematic configuration diagram illustrating still another shade apparatus for vehicles of the present disclosure.

FIG. 11 is a schematic configuration diagram illustrating yet another shade apparatus for vehicles of the present disclosure.

FIG. 12 is a schematic configuration diagram illustrating yet another shade apparatus for vehicles of the present disclosure.

FIG. 13 is a plan view illustrating another shoe and another guide member applicable to the shade apparatus for vehicles of the present disclosure.

FIG. 14 is a cross-sectional view taken along line XIV-XIV in FIG. 13.

### DESCRIPTION OF EMBODIMENTS

Next, embodiments for carrying out the aspects of the present disclosure will be described with reference to the drawings.

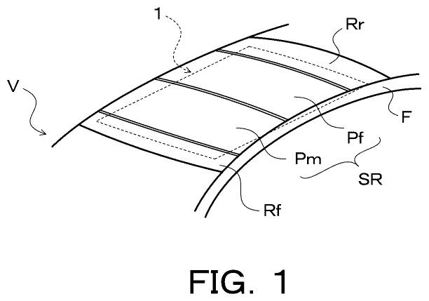

FIG. 1 is a perspective view illustrating a vehicle V including a shade apparatus for vehicles (hereinafter, simply referred to as “shade apparatus”) 1 of the present disclosure. The vehicle V includes a sunroof device SR provided between a front roof panel Rf and a rear roof panel Rr fixed to a vehicle body F. The shade apparatus 1 is attached to the vehicle body F so as to be located below a transparent movable panel Pm and a transparent fixed panel Pf of the sunroof device SR. Here, the shade apparatus 1 may be attached to the vehicle body F so as to be located below a fixed transparent roof (glass roof) provided between the front roof panel Rf and the rear roof panel Rr.

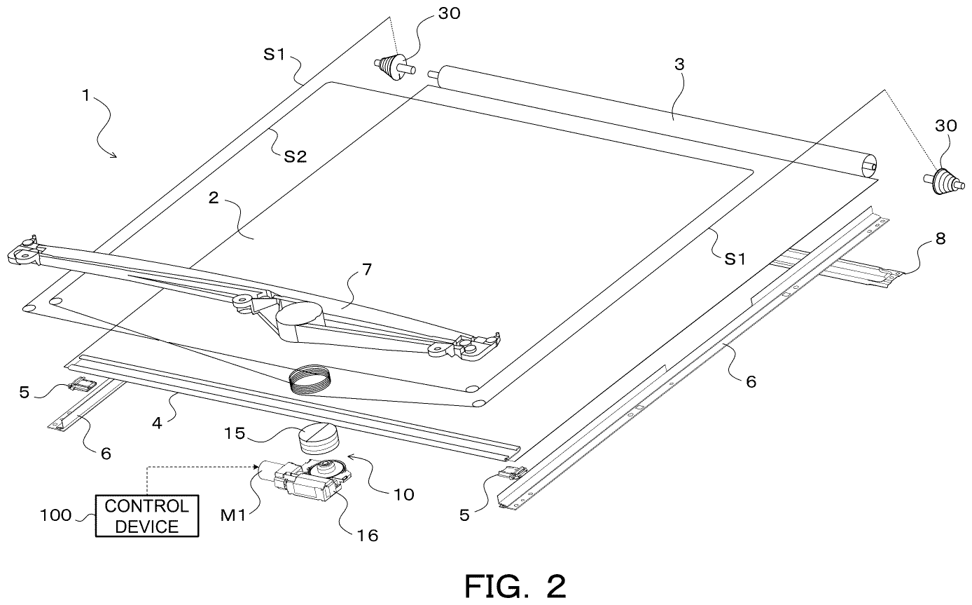

As illustrated in FIG. 2, the shade apparatus 1 includes a shade 2, a winding member 3, a shade bar 4, paired (two) shoes 5, paired (two) guide members 6, and a drive device 10 for opening and closing the shade 2. The shade 2 is, for example, a rectangular light shielding sheet made of cloth, and has the area capable of completely covering the light transmitting portions of the movable panel Pm and the fixed panel Pf of the sunroof device SR. Note that the shade 2 may have heat shielding properties.

The winding member 3 is a cylindrical body or a columnar body with a relatively small outer diameter (for example, about 10 mm). The proximal end portion of the shade 2 is fixed (locked) to the outer peripheral surface of the winding member 3. For example, a substantially frustoconical spool (wound member) 30 is coaxially fixed to each of both end portions of the winding member 3 in the axial direction. The paired (two) spools 30 are rotatable simultaneously and integrally with the winding member 3. By rotating the winding member 3 and the paired spools 30 in a predetermined winding direction about the axis, the shade 2 can be wound around the winding member 3 and opened.

The shade bar 4 is formed by, for example, extruding an aluminum alloy or the like, and has, for example, a substantially C-shaped cross-sectional shape. The shade bar 4 is fixed to the distal end portion of the shade 2 (end portion opposite to the proximal end portion fixed to the winding member 3). In the present embodiment, a cylindrical portion into which a rod material is inserted is formed at the distal end portion of the shade 2. The cylindrical portion and the rod material are fitted into a shade holding groove formed in the shade bar 4, so that the shade bar 4 is fixed to the distal end portion of the shade 2. In the present embodiment, each shoe 5 is formed of, for example, a resin containing potassium titanate fibers, and is fitted (fixed) to the corresponding end portion of the shade bar 4 in the longitudinal direction.

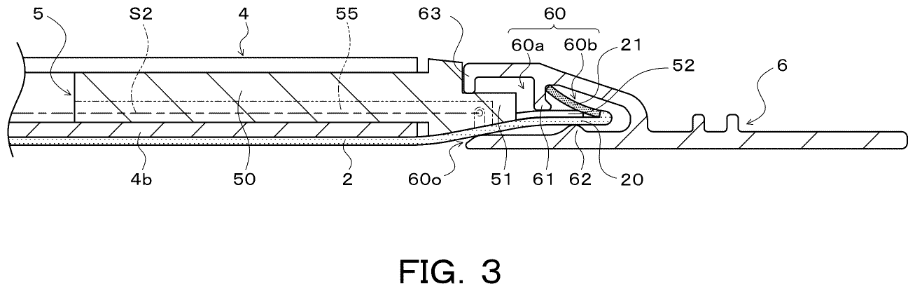

Each guide member 6 is formed by, for example, extruding an aluminum alloy or the like, and has a uniform cross-sectional shape in the longitudinal direction. Each guide member 6 slidably supports the corresponding shoe 5 and the corresponding side end portion 20 (see FIG. 3) of the shade 2. The paired guide members 6 are fixed to a housing 7 and a support member 8 via bolts or the like so as to extend in parallel to each other with a space corresponding to the width of the shade 2 therebetween. Note that each guide member 6 may be curved in the height direction (vertical direction) of the vehicle V so as to extend along the roof of the vehicle V, that is, the front roof panel Rf, the movable panel Pm, the fixed panel Pf, and the rear roof panel Rr.

The housing 7 houses the drive device 10. Paired brackets (not illustrated) that rotatably support the shaft portions of the corresponding spools 30 via bearings (not illustrated) are fixed to the support member 8. The housing 7 and the support member 8 are fixed to the vehicle body F in a manner that the winding member 3 extends in the width direction of the vehicle V and the paired guide members 6 extend in the front-rear direction of the vehicle V below the sunroof device SR. In the present embodiment, the housing 7 is located on the front side of the vehicle V, and the support member 8 is located on the rear side of the vehicle V.

FIG. 3 is an enlarged cross-sectional view illustrating the shade 2, the shade bar 4, the shoe 5, and the guide member 6. As illustrated in the drawing, a solidified portion 21 is formed at the side end portion 20 on both sides of the shade 2 in the width direction (extending direction of the winding member 3 and the shade bar 4). The solidified portion 21 is formed by applying a resin or attaching a sheet material such as a resin to the entire edge portion of the side end portion 20, and has higher strength than the remaining side end portion 20 (shade 2). The solidified portion 21 is folded so as to cover the remaining side end portion 20 from above, and is sewn to the remaining side end portion 20 at least at one place in the longitudinal direction. A base portion 4b on the side opposite to the opening side of the shade bar 4 abuts on the upper surface of the shade 2.

As illustrated in FIG. 3, each shoe 5 includes a fitting portion 50 fitted into the corresponding axial end portion of the shade bar 4, and a supported portion 51 slidably supported by the corresponding guide member 6. The supported portion 51 includes an insertion portion (pilot portion) 52 projecting to the side opposite to the fitting portion 50 side. The insertion portion 52 is a thin plate-shaped projecting piece with a narrower width than the supported portion 51. In a state where the fitting portion 50 is fitted into the end portion of the shade bar 4, the supported portion 51 of each shoe 5 projects outward from the shade bar 4, and the supported portion 51 and the insertion portion 52 abut on the upper surface of the side end portion 20 of the shade 2.

Furthermore, the insertion portion 52 is inserted below the folded side end portion 20 of the shade 2, that is, the solidified portion 21.

Each guide member 6 has a guide chamber 60 extending in the longitudinal direction (direction penetrating the paper surface in FIG. 3) and opened on one side in the width direction (left-right direction in FIG. 3). The paired guide members 6 are fixed to the housing 7 and the support member 8 in a manner that openings 600 of the guide chambers 60 face each other. In addition, each guide member 6 includes a first projection 61, a second projection 62, and a third projection 63 extending in the longitudinal direction. The first projection 61 projects from the upper inner surface of the guide member 6 defining the guide chamber 60 and faces the lower inner surface of the guide member 6 with a space therebetween.

The guide chamber 60 is thus partitioned by the first projection 61 into a first chamber 60a on the opening 600 side (left side in FIG. 3) and a second chamber 60b on the closed end side (right side in FIG. 3). The second projection 62 projects from the lower inner surface of the guide member 6 defining the guide chamber 60 on the closed end side of the first projection 61 and faces the upper inner surface of the guide member 6 with a space therebetween. The third projection 63 projects downward from the upper inner surface of the guide member 6 at the opening 600 of the guide chamber 60 and faces the lower inner surface of the guide member 6 with a space therebetween.

As illustrated in FIG. 3, the second chamber 60b is formed in a manner that the height gradually decreases as it is separated from the opening 600 of the guide chamber 60 in the width direction (left-right direction in FIG. 3). That is, the upper inner surface of the guide member 6 defining the second chamber 60b is formed so as to be inclined downward from the opening 600 side (first chamber 60a side) toward the closed end (right side in FIG. 3).

As illustrated in FIG. 3, (a part of) the supported portion 51 and the insertion portion 52 of each shoe 5 are inserted into the guide chamber 60 of the corresponding guide member 6 together with the side end portion 20 of the shade 2. More specifically, the insertion portion 52 and the side end portion 20 of the shade 2 are inserted into the second chamber 60b of the guide chamber 60 in a manner that the insertion portion 52 is supported by the first projection 61 from above and the distal end portion of the side end portion 20, that is, the solidified portion 21 abuts on the first projection 61 or the inclined inner surface of the guide chamber 60. The side end portion 20 of the shade 2 is supported by the second projection 62 from below in the second chamber 60b.

Furthermore, (a part of) the supported portion 51 is disposed in the first chamber 60a of the guide chamber 60 together with the side end portion 20 of the shade 2, and is supported by the third projection 63 from above. As a result, the supported portion 51 and the insertion portion 52 of each shoe 5 and the side end portion 20 of the shade 2 are slidably supported by the corresponding guide member 6. The step formed on the supported portion 51 and the third projection 63 abut with each other, so that the movement of the shoe 5 in the direction from the shade bar 4 toward the guide member 6 is restricted.

The drive device 10 of the shade apparatus 1 rotates the winding member 3 about the axis via one first string S1, and separates the shade bar 4, that is, the distal end portion of the shade 2 from the winding member 3 via one second string S2. As illustrated in FIG. 1, the drive device 10 includes a single drum member 15, a single motor M, and a power transmission mechanism 16.

The first string S1 is a wire (made of metal) with an outer diameter of, for example, about 0.5 to 1.0 mm. Here. The first string S1 may be a yarn or the like made of chemical fibers or the like. Both ends of the first string S1 are fixed (locked) to the corresponding spools 30, and the first string S1 is wound around each spool 30 in a direction opposite to the winding direction. Note that a spiral groove or a spirally extending step may be formed on the outer peripheral surface of each spool 30 so that the first string S1 is uniformly wound around the spool 30 without being entangled.

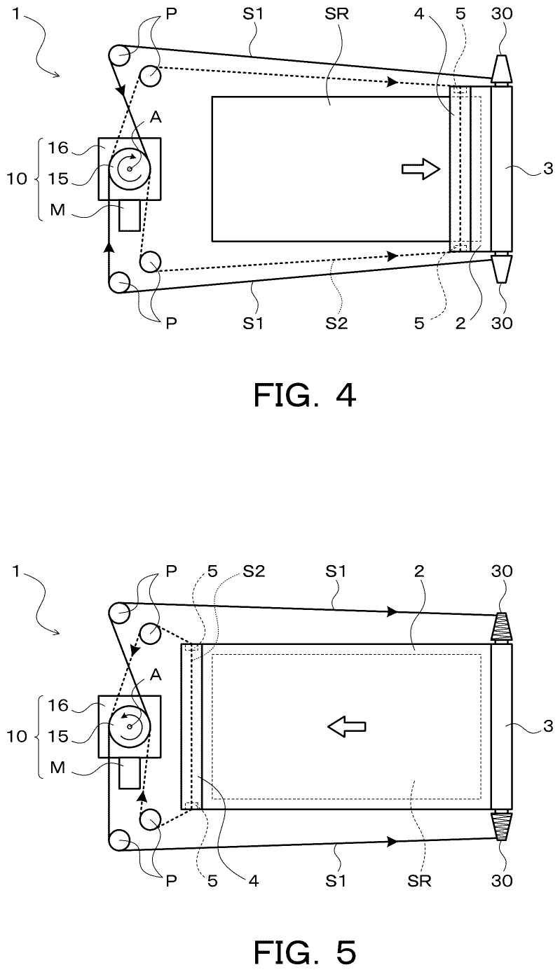

The central portion of the first string S1 is held by the drum member 15. The drum member 15 has a columnar outer peripheral surface and is rotatable about, for example, an axis A (see FIG. 4) extending in the vertical direction. In the present embodiment, the central portion of the first string S1 is inserted into the drum member 15 so as not to pass through the axis A, and is fixed to the drum member 15.

Furthermore, the portion on one end side and the portion on the other end side of the first string S1 project outward from different positions on the outer circumferential surface of the drum member 15 so as to be wound around the drum member 15 when 12 the drum member 15 rotates in a predetermined first direction about the axis A.

The second string S2 is also a wire (made of metal) with an outer diameter of, for example, about 0.5 to 1.0 mm. Here. The second string S2 may also be a yarn or the like made of chemical fibers or the like. In the present embodiment, the second string S2 is formed in an annular shape (loop shape). The second string S2 is slidably inserted into the first chamber 60a (guide chamber 60) of one guide member 6 and a string passage 55 (see FIG. 3) formed in one of the paired shoes 5 from the drive device 10 side, and further inserted into the space defined above the base portion 4b of the shade bar 4. The second string S2 inserted into the shade bar 4 is slidably inserted into the string passage 55 formed in the other of the paired shoes 5 and the first chamber 60a (guide chamber 60) of the other guide member 6, and drawn to the drive device 10 side. As a result, one (annular) second string S2 is supported by the shade bar 4 and the paired shoes 5 so as to be slidable in the width direction of the shade 2, and is connected to the distal end portion of the shade 2 via the shade bar 4 and the like.

A part of the second string S2 is inserted into the drum member 15 so as not to pass through the axis A and is fixed to the drum member 15, for example, on the lower stage side or the upper stage side of the first string S1. Furthermore, the portion of the second string S2 extending from the drum member 15 toward one shoe 5 (one end portion of the shade bar 4) and the portion of the second string S2 extending from the drum member 15 toward the other shoe 5 (other end portion of the shade bar 4) project outward from different positions on the outer circumferential surface of the drum member 15 so as to be wound around the drum member 15 when the drum member 15 rotates about the axis A in a second direction opposite to the first direction. Note that a spiral groove or a spirally extending step may be formed on the outer peripheral surface of the drum member 15 so that each of the first and second strings S1 and S2 is uniformly wound around the drum member 15 without being entangled.

The motor M rotates the drum member 15 in forward and reverse directions about the axis A via the power transmission mechanism 16. In the present embodiment, the motor M is, for example, a brushed DC motor, and is controlled by a control device 100 (see FIG. 1). The control device 100 includes a microcomputer including a CPU, a ROM, a RAM, an input and output interface, and the like, and controls the motor M in response to an operation of a shade opening and closing switch (not illustrated) by a user. The power transmission mechanism 16 includes, for example, a reducer, a gear mechanism, and the like. Here, the power transmission mechanism 16 may be omitted, and the motor M may be directly connected to the drum member 15. Moreover, the shade apparatus 1 includes a plurality of pulleys P (see FIG. 1) rotatably supported by the housing 7 or the like so as to regulate the path of the corresponding first string S1 or second string S2.

Next, the operation of the above shade apparatus 1 will be described with reference to FIGS. 4 and 5.

In a state where the shade 2 is drawn from the winding member 3 and is at least partially closed, when the user gives an instruction to open (fully open or half-open) the shade 2 via the shade opening and closing switch, the control device 100 controls the motor M of the drive device 10 to rotate the drum member 15 in the first direction (clockwise direction in FIG. 4) about the axis A as illustrated in FIG. 4. When the drum member 15 rotates in the first direction, as illustrated in FIG. 4, both the portion on one end side and the portion on the other end side of the first string S1 are wound around the drum member 15, and the second string S2 is unwound from the drum member 15 toward both one shoe 5 and the other shoe 5.

As a result, the first string S1 is pulled toward the drum member 15, so that the individual spools 30 and the winding member 3 rotate in the winding direction of the shade 2 about the axis. The movement of the shade bar 4 to the winding member 3 side is allowed based on the unwinding of the second string S2. As a result, the shade 2 can be opened by moving the shade bar 4 to the winding member 3 side while pulling the first string S1 to wind the shade 2 around the winding member 3.

On the other hand, in a state where the shade 2 is wound around the winding member 3 and is at least partially opened, when the user gives an instruction to close (fully close or half-close) the shade 2 via the shade opening and closing switch, the control device 100 controls the motor M of the drive device 10 to rotate the drum member 15 in the second direction (counterclockwise direction in FIG. 5) about the axis A as illustrated in FIG. 5. When the drum member 15 rotates in the second direction, as illustrated in FIG. 5, the first string S1 is unwound from the drum member 15 toward each spool 30, and both the portion of the second string S2 located between the drum member 15 and one shoe 5 and the portion of the second string S2 located between the drum member 15 and the other shoe 5 are wound around the drum member 15.

As a result, the second string S2 is pulled toward the drum member 15, and the shade bar 4 is separated from the winding member 3. The shade 2 is then drawn from the winding member 3 based on the movement of the shade bar 4, and the winding member 3 and the individual spools 30 rotate in the unwinding direction of the shade 2 about the axis. As a result, the shade 2 can be closed by pulling the second string S2, and both the portion on one end side and the portion on the other end side of the first string S1 can be wound around the corresponding spools 30 that rotate integrally with the winding member 3 based on the drawing of the shade 2.

As described above, the shade apparatus 1 includes two spools 30 as wound members rotatable coaxially and integrally with the winding member 3 that winds the shade 2. One end or the other end of one first string S1 such as a small-diameter wire or yarn is fixed to each spool 30 and wound around each spool 30 of the first string S1. In the shade apparatus 1, by pulling the first string S1 using the drive device 10 to rotate each spool 30 and the winding member 3 in the winding direction of the shade 2, the shade 2 can be wound around the winding member 3 and opened.

As a result, a biasing mechanism (retractor) that biases the shade 2 in the winding direction can be omitted from the winding member 3, and the winding member 3 can be largely reduced in diameter. By adopting the configuration in which the first string S1 is pulled to open the shade 2, the movable range of the shade 2 is not limited due to the restriction of the biasing mechanism (stress relaxation of a spring or the like). As a result, the shade apparatus 1 can be made compact in the height direction to improve the mountability of the shade apparatus 1, and the movable range of the shade 2 can be easily expanded. Furthermore, the overall weight reduction and cost reduction of the shade apparatus 1 can be achieved by omitting the biasing mechanism. The structure for regulating the path of the first string S1 can be simplified as compared with a geared cable or the like, thereby making the entire apparatus compact. Moreover, since the loss associated with the driving of the first string S1 is also reduced as compared with the geared cable or the like, it is possible to suppress an increase in size of the drive device 10.

The shade apparatus 1 includes the second string S2 connected to the distal end portion of the shade 2 via the shade bar 4, and the drive device 10 pulls the second string S2 to separate the distal end portion of the shade 2 from the winding member 3. As a result, by pulling the second string S2 using the drive device 10, the shade 2 can be drawn from the winding member 3 and closed. In addition, the structure for regulating the path of the second string S2 can also be simplified as compared with a geared cable or the like, thereby making the entire apparatus compact. Since the loss associated with the driving of the second string S2 is also reduced as compared with the geared cable or the like, it is possible to suppress an increase in size of the drive device 10.

The shade apparatus 1 further includes, as wound members, two spools 30 each of which is coaxially fixed to the corresponding axial end portion of the winding member 3. Both ends of the first string S1 are fixed to the corresponding spools 30, and the first string S1 is wound around each spool 30. Furthermore, the shade bar 4 is fixed to the distal end portion of the shade 2, and the second string S2 is connected to the shade 2 via the shade bar 4. As a result, the drive device 10 pulls the first string S1 to stably rotate the winding member 3 in the winding direction of the shade 2, and the drive device 10 pulls the second string S2 to separate the shade bar 4 from the winding member 3, so that the shade 2 can be closed.

Here, in the shade apparatus 1, one first string S1 may be divided into two. That is, one end sides of two first strings S1 may be fixed and wound around the corresponding spools 30, and the other ends of the two first strings S1 may be fixed to the drum member 15 in a manner that both of the two first strings S1 are wound around the drum member 15 when the drum member 15 rotates in the first direction. The second string S2 is not necessarily formed in an annular shape, and both end portions of one second string S2 may be fixed to the drum member 15. Furthermore, one ends of two second strings S2 may be fixed to the corresponding shoes 5 (end portions of the shade bar 4), and the other ends of the two second strings S2 may be fixed to the drum member 15 in a manner that both of the two second strings S2 are wound around the drum member 15 when the drum member 15 rotates in the second direction.

The drive device 10 of the shade apparatus 1 further includes the single drum member 15 that is rotatable about the axis A and the single motor M that rotates the drum member 15 in forward and reverse directions about the axis A. Furthermore, the first string S1 is wound around the drum member 15 when the drum member 15 rotates in the predetermined first direction. The second string S2 is wound around the drum member 15 when the drum member 15 rotates in the second direction opposite to the first direction.

According to such a drive device 10, by rotating the single drum member 15 in the first direction using the single motor M, the shade 2 can be wound around the winding member 3 and opened while allowing the movement of the shade bar 4 to the winding member 3 side. By rotating the single drum member 15 in the second direction opposite to the first direction using the single motor M, the shade bar 4 can be separated from the winding member 3 to close the shade 2, and the first string S1 can be wound around each spool 30 rotating based on the drawing of the shade 2. Furthermore, by using one drum member 15 and one motor M, the number of components of the drive device 10 can be reduced to achieve cost reduction, and the drive device 10 and thus the shade apparatus 1 can be reduced in size and weight.

Furthermore, in the shade apparatus 1, each of the paired guide members 6 has the guide chamber 60 extending in the longitudinal direction and opened on one side in the width direction. Each of the supported portions 51 of the paired shoes 5 abuts on the upper surface of the corresponding side end portion 20 of the shade 2, and each of the insertion portions 52 of the paired shoes 5 is inserted below the folded side end portion 20 of the shade 2, that is, the solidified portion 21. Further, the second string S2 is inserted into the guide chamber 60 of each guide member 6, more specifically, into the first chamber 60a. The folded side end portion 20 (solidified portion 21) of the shade 2 and the insertion portion 52 of the shoe 5 are inserted into the guide chamber 60 of the corresponding guide member 6, more specifically, into the second chamber 60b, and are slidably supported by the guide member 6. In this manner, the supported portion 51 of the shoe 5 is made to abut on the upper surface of the side end portion 20 of the shade 2 and inserted into the single guide chamber 60 together with the side end portion 20, so that the dimension of the guide member 6 that slidably supports the shade 2 and the shoe 5 in the height direction can be reduced while the removal of the shade 2 and the shoe 5 from the guide chamber 60 is successfully prevented. As a result, the shade apparatus 1 can be made compact in the height direction to improve the mountability of the shade apparatus 1. Note that, in the shade apparatus 1, each of the supported portions 51 of the paired shoes 5 may be fitted (fixed) to the corresponding end portion of the shade bar 4 in the longitudinal direction so as to abut on lower surface of the corresponding side end portion 20 of the shade 2.

Each of the guide members 6 includes the first projection 61 that extends in the longitudinal direction, projects from the upper inner surface of the guide member 6, and faces the lower inner surface of the guide member 6 with a space therebetween.

Furthermore, the guide chamber 60 is partitioned into the first chamber 60a on the opening 600 side and the second chamber 60b on the closed end side by the first projection 61, and the distal end of the insertion portion 52 of the shoe 5 and the side end portion 20 of the shade 2 are inserted into the second chamber 60b in a manner that the distal end of the side end portion 20, that is, the solidified portion 21 faces the opening 600 side, that is, the first projection 61 side. As a result, while the dimension of the guide member 6 in the height direction is reduced, the folded side end portion 20 of the shade 2 and the insertion portion 52 of the shoe 5 can be held in the second chamber 60b whose inlet is narrowed by the first projection 61, and the shade 2 and the shoe 5 can be successfully prevented from coming off (being removed) from each guide member 6 in the width direction.

Furthermore, the first projection 61 of each guide member 6 can abut on the distal end of the folded side end portion 20 of the shade 2, that is, the solidified portion 21, and can support the insertion portion 52 of the corresponding shoe 5 from above.

Therefore, the first projection 61 also functions as a retaining portion that restricts the movement of at least one of the folded side end portion 20 of the shade 2 or the insertion portion 52 of the shoe 5 to the opening 600 side. As a result, when the shade bar 4 (distal end portion of the shade 2) is moved toward and away from the winding member 3 by the drive device 10 to open and close the shade 2, it is possible to successfully prevent each side end portion 20 of the shade 2 and each shoe 5 from coming off from the guide chamber 60 of the corresponding guide member 6.

The guide chamber 60 of each guide member 6, that is, the second chamber 60b is formed in a manner that the height gradually decreases as it is separated from the opening 600 in the width direction of the shade 2. As a result, the folded side end portion 20 (solidified portion 21) of the shade 2 and the insertion portion 52 of each shoe 5 can be successfully held in the second chamber 60b of the guide chamber 60 while the dimension of each guide member 6 in the height direction is further reduced. Here, in each guide member 6, not only the second chamber 60b but also the first chamber 60a may be formed in a manner that the height gradually decreases as it is separated from the opening 600 in the width direction of the shade 2.

Here, the insertion portion 52 is not necessarily supported by the first projection 61, and may be separated from the first projection 61. Furthermore, the distal end of the solidified portion 21 does not necessarily abut on the inner surface defining the first projection 61 and the second chamber 60b, and in this case, the guide chamber 60 may be a single space not partitioned by the first chamber 60a and the second chamber 60b, in which the first projection 61 is omitted. The first projection 61 may project from the lower inner surface of the guide member 6 and face the upper inner surface of the guide member 6 with a space therebetween.

Moreover, each of the guide members 6 includes the second projection 62 that extends in the longitudinal direction, projects from the lower inner surface of the guide member 6 on the closed end side of the first projection 61, and faces the upper inner surface of the guide member 6 with a space therebetween. As a result, while the dimension of each guide member 6 in the height direction is reduced, the movement of the shade 2 and the shoe 5 in the vertical direction (height direction) can be restricted by the upper first projection 61 and the lower second projection 62 while the frictional resistance between the guide member 6 and the shade 2 and the shoe 5 is reduced. Here, the second projection 62 may project from the upper inner surface of the guide member 6 and face the lower inner surface of the guide member 6 with a space therebetween.

In a case where the geared cable or the like is slidably supported by the guide member, it is necessary to fill a space between the guide member and the geared cable or the like with a lubricant. However, in the shade apparatus 1, by adopting a configuration in which the shade 2 is opened and closed by pulling the first and second strings S1 and S2, the lubricant is unnecessary. Therefore, a support portion such as a geared cable, a partition wall for preventing contact between the shade 2 and the lubricant, and the like can be omitted from the guide member 6. As a result, the dimension of the guide member 6 in the height direction can be further reduced.

Furthermore, the shade bar 4 is fixed to the distal end portion of the shade 2, and each shoe 5 is fitted into the corresponding end portion of the shade bar 4. The shade bar 4 forms a space through which the second string S2 is inserted. Moreover, the second strings S2 are inserted into the space of the shade bar 4 from the drive device 10 side via the first chamber 60a (guide chamber 60) of one guide member 6 and the string passage 55 formed in one shoe 5, and is drawn to the drive device 10 side via the string passage 55 formed in the other shoe 5 and the first chamber 60a (guide chamber 60) of the other guide member 6. That is, in the shade apparatus 1, a small-diameter wire, yarn, or the like can be used as the second string S2. Therefore, it is possible to route the second string S2 between the drive device 10 and the shade bar 4 via the guide chamber 60 and the string passage 55 of the shoe 5 while suppressing the increase in size of the shoe 5 and the guide member 6. In the shade apparatus 1, the second string S2 is inserted into the first chamber 60a of the guide member 6. This makes it difficult for the occupant of the vehicle V to visually recognize the second string S2, and it is possible to successfully suppress interference between the second string S2 and the distal end of the side end portion 20 of the shade 2, that is, the solidified portion 21 inserted into the second chamber 60b.

Note that, in the above embodiment, the second string S2 is not necessarily inserted into the space of the shade bar 4 through the string passage 55 of the shoe 5, and may be inserted only into the first chamber 60a of each of the paired shoes 5. In the above embodiment, the shade apparatus 1 is attached to the vehicle body F so as to be located below the sunroof SR or the fixed transparent roof of the vehicle V, but it is not limited thereto. That is, the shade apparatus 1 may be provided on the rear window or the side window of the vehicle V.

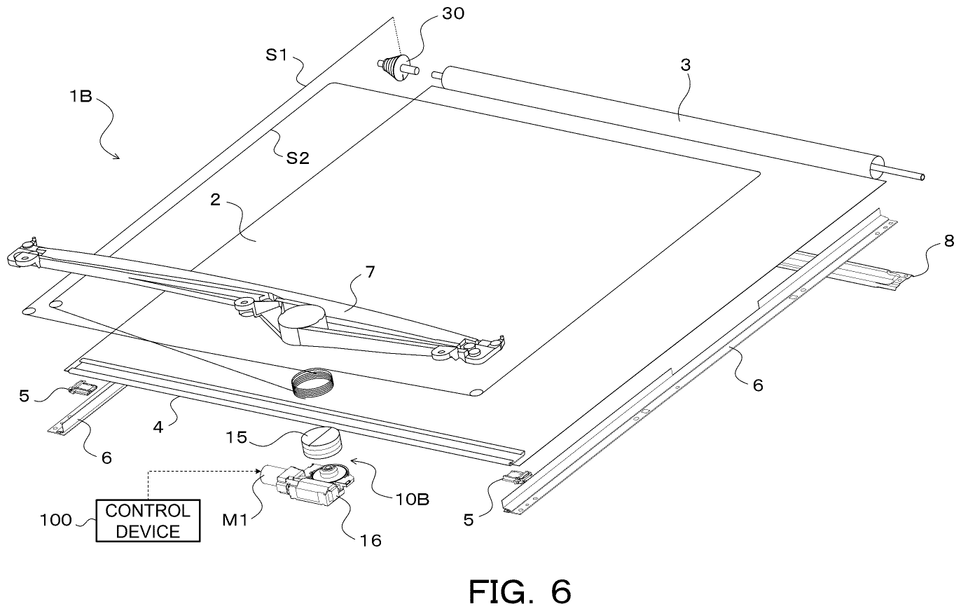

FIG. 6 is a schematic configuration diagram illustrating another shade apparatus 1B of the present disclosure. Note that, among the components of the shade apparatus 1B, the same elements as those of the shade apparatus 1 described above are denoted by the same reference numerals, and redundant description will be omitted.

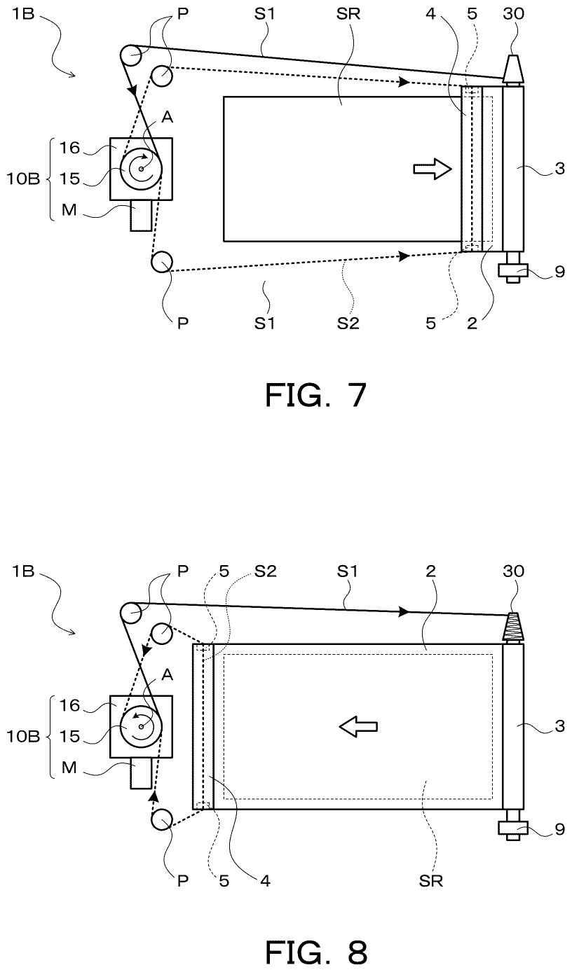

The shade apparatus 1B illustrated in FIG. 6 corresponds to an apparatus in which one of the two spools 30 is omitted from the shade apparatus 1 described above. That is, in the shade apparatus 1B, one spool (wound member) 30 is coaxially fixed to one axial end portion of the winding member 3. The other axial end portion of the winding member 3 is rotatably supported by a bracket 9 (see FIGS. 7 and 8) fixed to the support member 8 via a bearing (not illustrated). Furthermore, one end of the first string S1 is fixed (locked) to the spool 30, and the first string S1 is wound around the spool 30 in a direction opposite to the winding direction. The other end of the first string S1 is fixed (locked) to the drum member 15 in a manner that the first string S1 is wound around the drum member 15 when the drum member 15 rotates in a predetermined first direction about the axis A.

In a state where the shade 2 of the shade apparatus 1B is at least partially closed, when an instruction to open the shade 2 is given via a shade opening and closing switch, the control device 100 controls the motor M of a drive device 10B to rotate the drum member 15 in a predetermined first direction (clockwise direction in FIG. 7) about the axis A as illustrated in FIG. 7. When the drum member 15 rotates in the first direction, as illustrated in FIG. 7, the first string S1 is wound around the drum member 15, and the second string S2 is unwound from the drum member 15 toward both one shoe 5 and the other shoe 5. As a result, the first string S1 is pulled, so that the spool 30 and the winding member 3 rotate in the winding direction of the shade 2 about the axis. The movement of the shade bar 4 to the winding member 3 side is allowed based on the unwinding of the second string S2. As a result, the shade 2 can be opened by moving the shade bar 4 to the winding member 3 side while pulling the first string S1 to wind the shade 2 around the winding member 3.

On the other hand, in a state where the shade 2 of the shade apparatus 1B is at least partially opened, when an instruction to close the shade 2 is given via the shade opening and closing switch, the control device 100 controls the motor M of the drive device 10B to rotate the drum member 15 in a second direction (counterclockwise direction in FIG. 8) opposite to the first direction about the axis A as illustrated in FIG. 8. When the drum member 15 rotates in the second direction, as illustrated in FIG. 8, the first string S1 is unwound from the drum member 15 toward the spool 30, and both the portion of the second string S2 located between the drum member 15 and one shoe 5 and the portion of the second string S2 located between the drum member 15 and the other shoe 5 are wound around the drum member 15. As a result, the second string S2 is pulled toward the drum member 15, and the shade bar 4 is separated from the winding member 3. The shade 2 is then drawn from the winding member 3 based on the movement of the shade bar 4, and the winding member 3 and the spool 30 rotate in the unwinding direction of the shade 2 about the axis. As a result, the shade 2 can be closed by pulling the second string S2, and the first string S1 can be wound around the spool 30 that rotates based on the drawing of the shade 2.

Note that the shade apparatus 1B may also be attached to the vehicle body F so as to be located below the sunroof SR or the fixed transparent roof of the vehicle V, or may be provided on the rear window or the side window of the vehicle V.

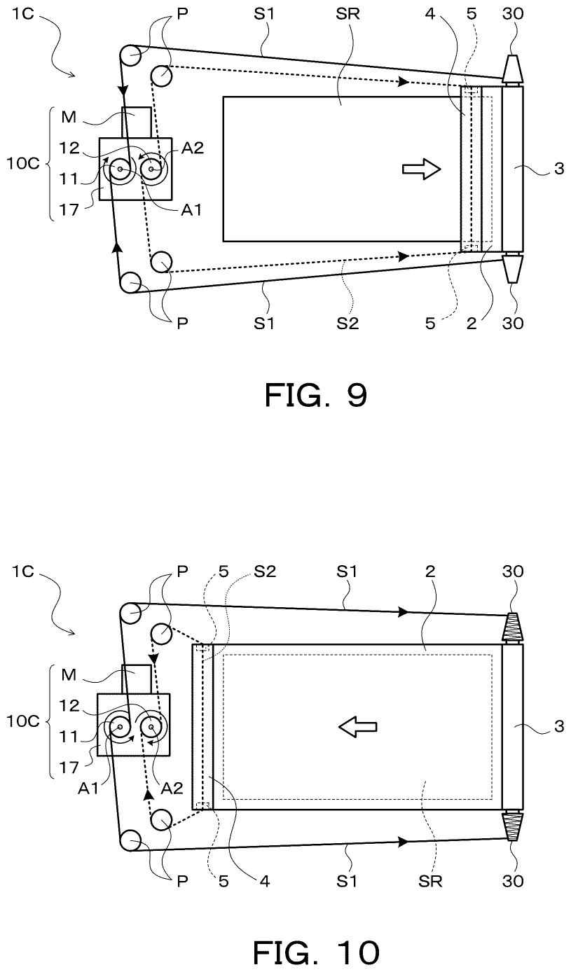

FIGS. 9 and 10 are schematic configuration diagrams illustrating still another shade apparatus 1C of the present disclosure. Note that, among the components of the shade apparatus 1C, the same elements as those of the shade apparatuses 1 and 1B described above are denoted by the same reference numerals, and redundant description will be omitted.

As illustrated in FIGS. 9 and 10, the shade apparatus 1C includes a drive device 10C that rotates the winding member 3 about the axis via one first string S1, and separates the shade bar 4, that is, the distal end portion of the shade 2 from the winding member 3 via the annular second string S2. As illustrated in the drawing, the drive device 10C includes a first drum member 11, a second drum member 12, a single motor M, and a power transmission mechanism 17.

In the shade apparatus 1C, both ends of the first string S1 are fixed (locked) to the corresponding spools 30, and the first string S1 is wound around each spool 30 in a direction opposite to the winding direction. The central portion of the first string S1 is held by the first drum member 11. The first drum member 11 has a columnar outer peripheral surface and is rotatable about, for example, an axis A1 extending in the vertical direction. In the shade apparatus 1C, the central portion of the first string S1 is inserted into the first drum member 11 so as not to pass through the axis A1, and is fixed to the first drum member 11. Furthermore, the portion on one end side and the portion on the other end side of the first string S1 project outward from different positions on the outer circumferential surface of the first drum member 11 so as to be wound around the first drum member 11 when the first drum member 11 rotates in a predetermined first tensile direction (clockwise direction in FIG. 9) about the axis A1.

In the shade apparatus 1C, the second string S2 is supported by the shade bar 4 and the paired shoes 5 so as to be slidable in the width direction of the shade 2, and is connected to the distal end portion of the shade 2 via the shade bar 4 and the like. In addition, a part of the second string S2 is held by the second drum member 12. The second drum member 12 has a columnar outer peripheral surface and is rotatable about, for example, an axis A2 extending in the vertical direction. In the shade apparatus 1C, a part of the second string S2 is inserted into the second drum member 12 so as not to pass through the axis A2, and is fixed to the second drum member 12. Furthermore, the portion of the second string S2 extending from the second drum member 12 toward one shoe 5 and the portion of the second string S2 extending from the second drum member 12 toward the other shoe 5 project outward from different positions on the outer circumferential surface of the second drum member 12 so as to be wound around the second drum member 12 when the second drum member 12 rotates in a predetermined second tensile direction (clockwise direction in FIG. 10) about the axis A2.

The motor M of the drive device 10C rotates the first and second drum members 11 and 12 in forward and reverse directions about the axis A1 or A2 via the power transmission mechanism 17, and is controlled by the control device 100. The power transmission mechanism 17 supports the first and second drum members 11 and 12 side by side so as to extend in parallel to each other, and rotates the first and second drum members 11 and 12 in opposite directions by the power from the motor M.

Moreover, the shade apparatus 1 includes a plurality of pulleys P rotatably supported by the housing 7 or the like so as to regulate the path of the corresponding first string S1 or second string S2.

In a state where the shade 2 of the shade apparatus 1C is at least partially closed, when an instruction to open the shade 2 is given via a shade opening and closing switch, the control device 100 controls the motor M of the drive device 10C to rotate the first drum member 11 in the first tensile direction (clockwise direction in FIG. 9) about the axis A1 and rotate the second drum member 12 in a direction opposite to the second tensile direction (counterclockwise direction in FIG. 9) about the axis A2, as illustrated in FIG. 9. When the first drum member 11 rotates in the first tensile direction, both the portion on one end side and the portion on the other end side of the first string S1 are wound around the first drum member 11. When the second drum member 12 rotates in a direction opposite to the second tensile direction, the second string S2 is unwound from the second drum member 12 toward both one shoe 5 and the other shoe 5. As a result, the first string S1 is pulled toward the first drum member 11, so that the individual spools 30 and the winding member 3 rotate in the winding direction of the shade 2 about the axis. The movement of the shade bar 4 to the winding member 3 side is allowed based on the unwinding of the second string S2. As a result, the shade 2 can be opened by moving the shade bar 4 to the winding member 3 side while pulling the first string S1 to wind the shade 2 around the winding member 3.

On the other hand, in a state where the shade 2 of the shade apparatus 1C is at least partially opened, when an instruction to close the shade 2 is given via the shade opening and closing switch, the control device 100 controls the motor M of the drive device 10C to rotate the first drum member 11 in a direction opposite to the first tensile direction (counterclockwise direction in FIG. 10) about the axis A1 and rotate the second drum member 12 in the second tensile direction (clockwise direction in FIG. 10) about the axis A2, as illustrated in FIG. 10. When the first drum member 11 rotates in a direction opposite to the first tensile direction, the first string S1 is unwound from the first drum member 11 toward each spool 30. When the second drum member 12 rotates in the second tensile direction, both the portion of the second string S2 located between the second drum member 12 and one shoe 5 and the portion of the second string S2 located between the second drum member 12 and the other shoe 5 are wound around the second drum member 12. As a result, the second string S2 is pulled toward the second drum member 12, and the shade bar 4 is separated from the winding member 3. The shade 2 is then drawn from the winding member 3 based on the movement of the shade bar 4, and the winding member 3 and the individual spools 30 rotate in the unwinding direction of the shade 2 about the axis. As a result, the shade 2 can be closed by pulling the second string S2, and both the portion on one end side and the portion on the other end side of the first string S1 can be wound around the corresponding spools 30 that rotate based on the drawing of the shade 2.

Furthermore, according to the drive device 10C, since the height of each of the first drum member 11 corresponding to the winding member 3 and the second drum member 12 corresponding to the shade bar 4 can be reduced, the shade apparatus 1C can be made more compact in the height direction. By using one motor M, the number of components of the drive device 10C can be reduced to achieve cost reduction.

Note that the shade apparatus 1C is not limited to an apparatus disposed below the sunroof SR or the like of the vehicle V, and may be provided on the rear window or the side window of the vehicle V. The shade apparatus 1C may also include a single spool 30 that is coaxially and integrally rotatable with the winding member 3, and one first string S1 having one end fixed to the spool 30. Furthermore, depending on the winding mode of the first string S1 and the second string S2 around the first and second drum members 11 and 12, the power transmission mechanism 17 may be configured to rotate the first and second drum members 11 and 12 in the same direction by the power from the motor M. Also in the shade apparatus 1C, the second string S2 is not necessarily formed in an annular shape, and both end portions of one second string S2 may be fixed to the second drum member 12. Moreover, one ends of two second strings S2 may be fixed to the corresponding shoes 5 (end portions of the shade bar 4), and the other ends of the two second strings S2 may be fixed to the second drum member 12 in a manner that both of the two second strings S2 are wound around the second drum member 12 when the second drum member 12 rotates in the second tensile direction.

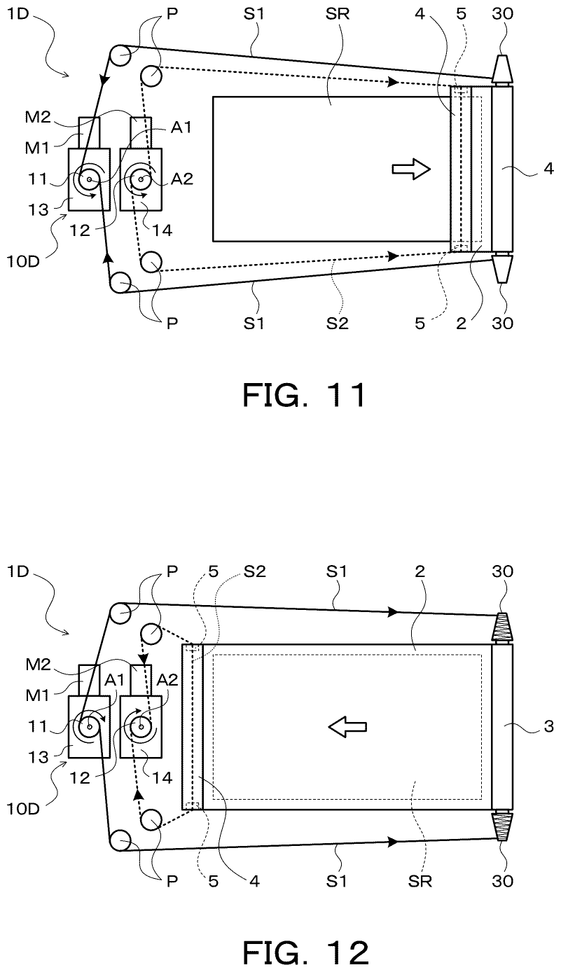

FIGS. 11 and 12 are schematic configuration diagrams illustrating yet another shade apparatus 1D of the present disclosure. Note that, among the components of the shade apparatus 1D, the same elements as those of the shade apparatuses 1, 1B, and 1C described above are denoted by the same reference numerals, and redundant description will be omitted.

As illustrated in FIGS. 11 and 12, the shade apparatus 1D includes a drive device 10D that rotates the winding member 3 about the axis via one first string S1, and separates the shade bar 4, that is, the distal end portion of the shade 2 from the winding member 3 via the annular second string S2. As illustrated in the drawing, the drive device 10D includes the first drum member 11, the second drum member 12, a first motor M1, a second motor M2, a first power transmission mechanism 13, and a second power transmission mechanism 14.

In the shade apparatus 1D, both the portion on one end side and the portion on the other end side of the first string S1 are wound around the first drum member 11 when the first drum member 11 rotates in a predetermined first tensile direction (counterclockwise direction in FIG. 11) about the axis A1. When the second drum member 12 rotates in a predetermined second tensile direction (clockwise direction in FIG. 12) about the axis A2, the portion of the second string S2 located between the second drum member 12 and one shoe 5 (one end portion of the shade bar 4) and the portion of the second string S2 located between the second drum member 12 and the other shoe 5 (the other end portion of the shade bar 4) are wound around the second drum member 12.

The first motor M1 is, for example, a brushed DC motor controlled by the control device 100, and rotates the first drum member 11 in forward and reverse directions about the axis A1 via the first power transmission mechanism 13. The second motor M2 is, for example, a brushed DC motor controlled by the control device 100, and rotates the second drum member 12 in forward and reverse directions about the axis A2 via the second power transmission mechanism 14. The first and second power transmission mechanisms 13 and 14 include, for example, a reducer, a gear mechanism, and the like. Here, the first and second power transmission mechanisms 13 and 14 may be omitted, and the first and second motors M1 and M2 may be directly connected to the corresponding first and second drum members 11 and 12. Moreover, the shade apparatus 1 includes a plurality of pulleys P rotatably supported by the housing 7 or the like so as to regulate the path of the corresponding first string S1 or second string S2.

In a state where the shade 2 of the shade apparatus 1D is at least partially closed, when an instruction to open the shade 2 is given via a shade opening and closing switch, the control device 100 controls the first motor M1 of the drive device 10D to rotate the first drum member 11 in the first tensile direction (counterclockwise direction in FIG. 11) about the axis A1, and controls the second motor M2 of the drive device 10D to rotate the second drum member 12 in a direction opposite to the second tensile direction (counterclockwise direction in FIG. 11) about the axis A2, as illustrated in FIG. 11. When the first drum member 11 rotates in the first tensile direction, both the portion on one end side and the portion on the other end side of the first string S1 are wound around the first drum member 11. When the second drum member 12 rotates in a direction opposite to the second tensile direction, the second string S2 is unwound from the second drum member 12 toward both one shoe 5 and the other shoe 5. As a result, the first string S1 is pulled toward the first drum member 11, so that the individual spools 30 and the winding member 3 rotate in the winding direction of the shade 2 about the axis. The movement of the shade bar 4 to the winding member 3 side is allowed based on the unwinding of the second string S2. As a result, the shade 2 can be opened by moving the shade bar 4 to the winding member 3 side while pulling the first string S1 to wind the shade 2 around the winding member 3.

On the other hand, in a state where the shade 2 of the shade apparatus 1D is at least partially opened, when an instruction to close the shade 2 is given via the shade opening and closing switch, the control device 100 controls the first motor M1 of the drive device 10D to rotate the first drum member 11 in a direction opposite to the first tensile direction (clockwise direction in FIG. 12) about the axis A1, and controls the second motor M2 of the drive device 10D to rotate the second drum member 12 in the second tensile direction (clockwise direction in FIG. 12) about the axis A2, as illustrated in FIG. 12. When the first drum member 11 rotates in a direction opposite to the first direction, the first string S1 is unwound from the first drum member 11 toward each spool 30. When the second drum member 12 rotates in the second tensile direction, both the portion of the second string S2 located between the second drum member 12 and one shoe 5 and the portion of the second string S2 located between the second drum member 12 and the other shoe 5 are wound around the second drum member 12. As a result, the second string S2 is pulled toward the second drum member 12, and the shade bar 4 is separated from the winding member 3. The shade 2 is then drawn from the winding member 3 based on the movement of the shade bar 4, and the winding member 3 and the individual spools 30 rotate in the unwinding direction of the shade 2 about the axis. As a result, the shade 2 can be closed by pulling the second string S2, and both the portion on one end side and the portion on the other end side of the first string S1 can be wound around the corresponding spools 30 that rotate based on the drawing of the shade 2.

Furthermore, according to the drive device 10D, since the height of each of the first drum member 11 corresponding to the winding member 3 and the second drum member 12 corresponding to the shade bar 4 can be reduced, the shade apparatus 1D can be made more compact in the height direction. In the drive device 10D, by adjusting the rotation speeds of the first and second motors M1 and M2 at the time of opening and closing the shade 2, the occurrence of slack of the shade 2 can be successfully suppressed.

Note that the shade apparatus 1D is not limited to an apparatus disposed below the sunroof SR or the like of the vehicle V, and may be provided on the rear window or the side window of the vehicle V. The shade apparatus 1D may also include a single spool 30 that is coaxially and integrally rotatable with the winding member 3, and one first string S1 having one end fixed to the spool 30. Also in the shade apparatus 1D, the second string S2 is not necessarily formed in an annular shape, and both end portions of one second string S2 may be fixed to the second drum member 12. One ends of two second strings S2 may be fixed to the corresponding shoes 5 (end portions of the shade bar 4), and the other ends of the two second strings S2 may be fixed to the second drum member 12 in a manner that both of the two second strings S2 are wound around the second drum member 12 when the second drum member 12 rotates in the second tensile direction.

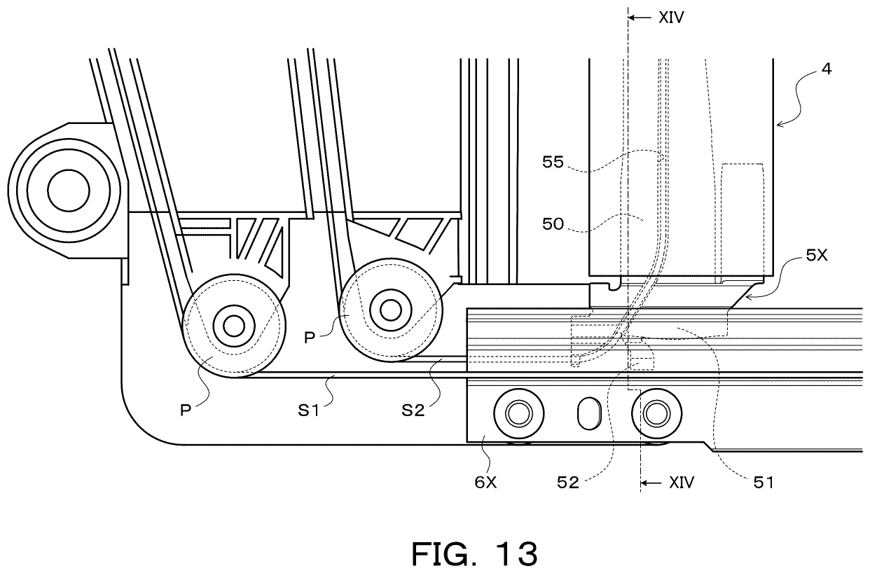

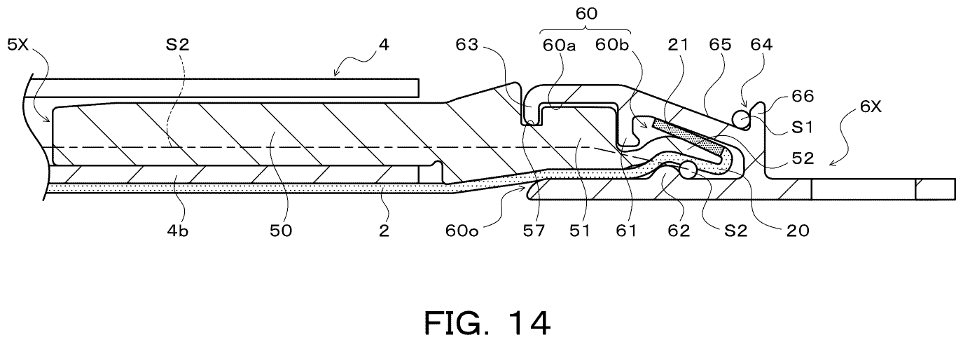

FIG. 13 is a plan view illustrating another shoe 5X and another guide member 6X applicable to the shade apparatuses 1, 1B, 1C, and 1D described above, and FIG. 14 is a cross-sectional view taken along line XIV-XIV in FIG. 13. Note that, among the components of the shoe 5X and the guide member 6X, the same elements as those of the shoe 5 described above and the same elements as those of the guide member 6 described above are denoted by the same reference numerals, and redundant description will be omitted.

As illustrated in FIGS. 13 and 14, the shoe 5X includes the fitting portion 50 fitted into the corresponding axial end portion of the shade bar 4, and the supported portion 51 slidably supported by the corresponding guide member 6X. The supported portion 51 includes the insertion portion (pilot portion) 52. The insertion portion 52 of the shoe 5X is also a thin plate-shaped projecting piece with a narrower width than the supported portion 51, and projects from the supported portion 51 to the side opposite to the fitting portion 50 side. As illustrated in FIG. 14, the guide member 6X includes the guide chamber 60 extending in the longitudinal direction (direction penetrating the paper surface in FIG. 14) and opened on one side in the width direction (left-right direction in FIG. 14) of the shade 2, and the first projection 61, the second projection 62, and the third projection 63 each extending in the longitudinal direction.

The first projection 61 projects from the upper inner surface of the guide member 6X defining the guide chamber 60, faces the lower inner surface of the guide member 6X with a space therebetween, and partitions the guide chamber 60 into the first chamber 60a on the opening 600 side and the second chamber 60b on the closed end side. The second projection 62 projects from the lower inner surface of the guide member 6X on the closed end side of the first projection 61 and faces the upper inner surface of the guide member 6X with a space therebetween. The third projection 63 projects downward from the upper inner surface of the guide member 6X at the opening 600 of the guide chamber 60 and faces the lower inner surface of the guide member 6X with a space therebetween. Here, the first projection 61 may project from the lower inner surface of the guide member 6X and face the upper inner surface of the guide member 6X with a space therebetween, and the second projection 62 may project from the upper inner surface of the guide member 6X and face the lower inner surface of the guide member 6X with a space therebetween. As illustrated in FIG. 14, the upper inner surface of the guide member 6X defining the second chamber 60b is inclined downward from the opening 600 side (first chamber 60a side) toward the closed end, and the second chamber 60b of the guide member 6X is also formed in a manner that the height gradually decreases as it is separated from the opening 600 in the width direction.

As illustrated in FIG. 14, (a part of) the supported portion 51 and the insertion portion 52 of the shoe 5X are inserted into the guide chamber 60 of the corresponding guide member 6X together with the side end portion 20 of the shade 2, and are slidably supported by the guide member 6X. More specifically, the supported portion 51 and the insertion portion 52 of the shoe 5X abut on the upper surface of the side end portion 20 of the shade 2, and the insertion portion 52 is inserted below the folded side end portions 20 of the shade 2, that is, the solidified portion 21. Furthermore, the folded side end portion 20 (solidified portion 21) of the shade 2 and the insertion portion 52 of the shoe 5X are inserted into the second chamber 60b in a manner that the solidified portion 21 abuts on the inclined inner surface of the guide member 6X defining the second chamber 60b.

The first projection 61 of the guide member 6X faces the end surface of the solidified portion 21 of the shade 2 with a space therebetween in the width direction of the shade 2, and faces the upper surface of the insertion portion 52 with a small space in the height direction. Furthermore, the second projection 62 supports the side end portion 20 of the shade 2 from below in the second chamber 60b. In the shoe 5X, as illustrated in FIG. 14, the insertion portion 52 is curved upward so as to pass between the first projection 61 and the lower inner surface of the guide member 6X, and is curved downward so as to pass between the second projection 62 and the upper inner surface of the guide member 6X. Further, the supported portion 51 of the shoe 5X includes an engaging recess 57 extending in parallel to the longitudinal direction of the guide member 6X, and the third projection 63 of the guide member 6X is slidably fitted (loosely fitted) into the engaging recess 57 from above. As a result, the movement of the shoe 5X in the width direction of the shade 2 with respect to the guide member 6X is restricted.

As illustrated in FIGS. 13 and 14, the second string S2 is slidably inserted into the second chamber 60b (guide chamber 60) of one guide member 6X and the string passage 55 (see FIG. 13) formed in one of paired shoes 5X from the drive device 10 side, and further inserted into the space defined above the base portion 4b of the shade bar 4. The second string S2 inserted into the shade bar 4 is slidably inserted into the string passage 55 formed in the other of the paired shoes 5X and the second chamber 60b (guide chamber 60) of the other guide member 6X, and drawn toward the drive device 10 side. As a result, one (annular) second string S2 is supported by the shade bar 4 and the paired shoes 5X so as to be slidable in the width direction of the shade 2, and is connected to the distal end portion of the shade 2 via the shade bar 4 and the like.

The guide member 6X includes a string guide portion 64 that extends in the longitudinal direction and slidably supports the first string S1 outside the guide chamber 60, more specifically, the second chamber 60b. The string guide portion 64 is a recess defined by an inclined surface 65 formed on the guide member 6X and a wall portion 66 projecting upward from the inclined surface 65. The inclined surface 65 is formed on the guide member 6X so as to extend in the longitudinal direction and to be inclined downward as being separated from the opening 600 in the width direction of the shade 2 on the upper side of the second chamber 60b. The wall portion 66 is formed on the guide member 6X so as to extend in the longitudinal direction and project upward from an end portion of the inclined surface 65 on the side opposite to the opening 600 side.

Also in the shade apparatuses 1 to 1D including the shoe 5X and the guide member 6X described above, it is possible to reduce the dimension of the guide member 6X that slidably supports the shade 2 and the shoe 5X in the height direction while successfully preventing the removal of the shade 2 and the shoe 5X from the guide chamber 60. As a result, the shade apparatuses 1 to 1D can be made compact in the height direction to improve the mountability of the shade apparatuses 1 to 1D. Note that, the supported portion 51 of the shoe 5X may be fitted (fixed) to the corresponding end portion of the shade bar 4 in the longitudinal direction so as to abut on lower surface of the corresponding side end portion 20 of the shade 2.

The guide chamber 60 of the guide member 6X is partitioned into the first chamber 60a on the opening 600 side and the second chamber 60b on the closed end side by the first projection 61, and the folded side end portion 20 (solidified portion 21) of the shade 2 and the insertion portion 52 of the shoe 5X are inserted into the second chamber 60b in a manner that the solidified portion 21 abuts on the inner surface of the guide member 6X defining the second chamber 60b. As a result, while the dimension of the guide member 6X in the height direction is reduced, the folded side end portion 20 of the shade 2 and the insertion portion 52 of the shoe 5X can be held in the second chamber 60b whose inlet is narrowed by the first projection 61, and the shade 2 and the shoe 5X can be successfully prevented from coming off (being removed) from each guide member 6X in the width direction.

Moreover, the guide chamber 60 of the guide member 6X, that is, the second chamber 60b is formed in a manner that the height gradually decreases as it is separated from the opening 600 in the width direction of the shade 2. As a result, the folded side end portion 20 (solidified portion 21) of the shade 2 and the insertion portion 52 of each shoe 5X can be successfully held in the second chamber 60b of the guide chamber 60 while the dimension of each guide member 6X in the height direction is further reduced. Here, in each guide member 6X, not only the second chamber 60b but also the first chamber 60a may be formed in a manner that the height gradually decreases as it is separated from the opening 600 in the width direction of the shade 2.

As can be seen from FIG. 14, the first projection 61 of each guide member 6X can abut on the distal end of the folded side end portion 20 of the shade 2, that is, the solidified portion 21, and can support the upward curved portion of the insertion portion 52 of the corresponding shoe 5X. Therefore, the first projection 61 also functions as a retaining portion that restricts the movement of the folded side end portion 20 of the shade 2 and the insertion portion 52 of the shoe 5X to the opening 600 side. As a result, when the shade bar 4 (distal end portion of the shade 2) is moved toward and away from the winding member 3 by the drive device 10 to open and close the shade 2, it is possible to successfully prevent each side end portion 20 of the shade 2 and each shoe 5X from coming off from the guide chamber 60 of the corresponding guide member 6X.

Moreover, the guide member 6X includes the second projection 62 that extends in the longitudinal direction, projects from the lower inner surface of the guide member 6X on the closed end side of the first projection 61, and faces the upper inner surface of the guide member 6X with a space therebetween. As a result, while the dimension of each guide member 6X in the height direction is reduced, the movement of the shade 2 and the shoe 5X in the vertical direction (height direction) can be restricted by the upper first projection 61 and the lower second projection 62 while the frictional resistance between the guide member 6X and the shade 2 and the shoe 5X is reduced. In addition, as can be seen from FIG. 14, the second projection 62 also functions as a string retaining portion that restricts the removal of the second string S2 from the second chamber 60b (guide chamber 60). This makes it possible to stably and smoothly open and close the shade 2 based on pulling or unwinding of the second string S2. Note that the string retaining portion formed in the guide member 6X only needs to restrict the removal of the second string S2 from the second chamber 60b, and is not limited to the second projection 62 projecting upward from the lower inner surface. That is, the string retaining portion of the guide member 6X may be, for example, a recess that is further recessed downward from the inner surface on the lower side and in which the second string S2 is disposed.

The insertion portion 52 of the shoe 5X is curved so as to pass between the first projection 61 and the lower inner surface of the guide member 6X and pass between the second projection 62 and the upper inner surface of the guide member 6X. As a result, the movement of the insertion portion 52 of the shoe 5X and the folded side end portion 20 (solidified portion 21) of the shade 2 to the opening 600 side of the guide chamber 60 can be successfully restricted by the first and second projections 61 and 62.

Furthermore, the guide member 6X includes the third projection 63, and the third projection 63 functions as a shoe retaining portion that engages with the engaging recess 57 of the shoe 5X to restrict the removal of the shoe 5X from the guide chamber 60. As a result, when the shade bar 4, that is, the distal end portion of the shade 2 is moved toward and away from the winding member 3 to open and close the shade 2, the shade 2 and the shoe 5X can be stably and smoothly slidably supported by the guide member 6X.

The guide member 6X includes a string guide portion 64 that extends in the longitudinal direction and slidably supports the first string S1 outside the guide chamber 60, more specifically, the second chamber 60b. As a result, the shade 2 can be stably and smoothly wound around the winding member 3 or unwound from the winding member 3 based on pulling or unwinding of the first string S1.

Furthermore, the guide member 6X includes the inclined surface 65 extending in the longitudinal direction and inclined downward as being separated from the opening 600 in the width direction of the shade 2 and the wall portion 66 extending in the longitudinal direction and projecting upward from the inclined surface 65, and the string guide portion 64 is a recess defined by the inclined surface 65 and the wall portion 66. This makes it possible to successfully prevent the first string S1 from swinging in the width direction of the shade 2 when the shade 2 is opened and closed.

### SUMMARY OF EMBODIMENTS

As described above, the shade apparatus for vehicles of the present disclosure is a shade apparatus for vehicles (1, 1B, 1C, 1D) that is provided on a roof (Pm, Pf) of a vehicle (V), winds a shade (2) around a winding member (3), and draws the shade from the winding member (3), the shade apparatus for vehicles including paired shoes (5, 5X) provided at corresponding side end portions (20, 21) of the shade (2), paired guide members (6, 6X) extending in a longitudinal direction and each including a guide chamber (60, 60a, 60b) opened on one side in a width direction, a string (S2) inserted into the guide chamber (60, 60a, 60b) of each of the guide members (6, 6X) and connected to a distal end portion of the shade (2), and a drive device (10, 10B, 10C, 10D) that pulls the string (S2) to separate the distal end portion of the shade (2) from the winding member (3), the side end portion (20, 21) of the shade (2) is folded to an opening (600) side of the guide chamber (60, 60a, 60b), each of the shoes (5, 5X) includes an insertion portion (52) to be inserted into a folded side end portion (20, 21) of the shade, and the folded side end portion (20, 21) of the shade (2) and the insertion portion (52) of each of the shoes (5, 5X) are inserted into the guide chamber (60, 60a, 60b) of each of the guide members (6, 6X) and are slidably supported by each of the guide members (6, 6X).

The shade apparatus for vehicles of the present disclosure includes the paired shoes provided at the corresponding side end portions of the shade, the paired guide members extending in the longitudinal direction and each including the guide chamber opened on one side in the width direction, the string inserted into the guide chamber of each of the guide members and connected to the distal end portion of the shade, and the drive device that pulls the string to separate the distal end portion of the shade from the winding member. The side end portion of the shade is folded to the opening side of the guide chamber, and each of the shoes includes the insertion portion to be inserted into the folded side end portion of the shade. The folded side end portion of the shade and the insertion portion of each of the shoes are inserted into the guide chamber of each of the guide members and are slidably supported by each of the guide members. In this manner, by inserting the insertion portion of each of the shoes into the folded side end portion of the shade, and inserting the insertion portion and the folded side end portion into the single guide chamber, the dimension of each of the guide members that slidably supports the shade and each of the shoes in the height direction can be reduced while the removal of the shade and each of the shoes from the guide chamber is successfully prevented. As a result, the shade apparatus for vehicles can be made compact in the height direction to improve the mountability of the shade apparatus for vehicles.

Each of the guide members (6, 6X) may include a retaining portion (61) that restricts movement of the folded side end portion (20, 21) of the shade (2) and the insertion portion (52) of each of the shoes (5, 5X) to the opening (600) side.

As a result, when the distal end portion of the shade is moved toward and away from the winding member to open and close the shade, it is possible to successfully prevent the side end portion of the shade and the shoe from coming off from the guide chamber of the guide member.

Furthermore, the retaining portion may be a projection (61) that extends in the longitudinal direction, projects from an upper or lower inner surface of each of the guide members (6, 6X), and faces the lower or upper inner surface of each of the guide members (6, 6X) with a space between the retaining portion and the upper or lower inner surface, the guide chamber (60) may be partitioned into a first chamber (60a) on an opening (600) side and a second chamber (60b) on a closed end side by the projection (61), the string (S2) may be inserted into the second chamber (60b), and the folded side end portion (20, 21) of the shade (2) and the insertion portion (52) of each of the shoes (5, 5X) may be inserted into the second chamber (60b).

As a result, while the dimension of the guide member in the height direction is reduced, the folded side end portion of the shade and the insertion portion of the shoe can be held in the second chamber whose inlet is narrowed by the projection, and thus the shade and the shoe can be successfully prevented from coming off (being removed) from each guide member in the width direction when the shade is opened and closed.

The guide chamber (60, 60b) may be formed so as to gradually decrease in height as being separated from the opening (600) in the width direction.

As a result, the folded side end portion of the shade and the insertion portion of the shoe can be successfully held in the guide chamber while the dimension of the guide member in the height direction is further reduced.

Furthermore, each of the guide members (6, 6X) may include a string retaining portion (62) that extends in the longitudinal direction and restricts removal of the string (S2) from the guide chamber (60, 60a, 60b).

This makes it possible to stably and smoothly open and close the shade based on pulling or unwinding of the string.

The projection (61) may project from the upper inner surface of each of the guide members (6, 6X) and face the lower inner surface of each of the guide members (6, 6X) with a space between the projection and the lower inner surface, each of the guide members (6, 6X) may include a second projection (62) that extends in the longitudinal direction, projects from the lower inner surface of each of the guide members (6, 6X) on a closed end side of the projection (61), and faces the upper inner surface of each of the guide members (6, 6X) with a space between the second projection and the upper inner surface, the side end portion (20) of the shade (2) may be supported from below by the second projection (62), and the second projection (62) may restrict removal of the string (S2) from the guide chamber (60, 60a, 60b).

As a result, while the dimension of the guide member in the height direction is reduced, the movement of the shade and the shoe in the vertical direction (height direction) can be restricted by the upper projection and the lower second projection while the frictional resistance between the guide member and the shade and the shoe is reduced, and the removal of the string from the guide chamber can be restricted by the second projection.

Moreover, the insertion portion (52) of each of the shoes (5X) may be curved so as to pass between the projection (61) and the lower inner surface of each of the guide members (6X) and pass between the second projection (62) and the upper inner surface of each of the guide members (6X).

As a result, the movement of the insertion portion of the shoe and the folded side end portion of the shade to the opening side of the guide chamber can be successfully restricted by the projection and the second projection.

Each of the guide members (6X) may include a shoe retaining portion (63) that engages with a part (57) of each of the shoes (5X) to restrict removal of each of the shoes (5X) from the guide chamber (60, 60a, 60b).

As a result, when the distal end portion of the shade is moved toward and away from the winding member to open and close the shade, the shoe and the shade can be stably and smoothly slidably supported by the guide member.

The shade apparatus for vehicles (1, 1B, 1C, 1D) may include a wound member (30) that is rotatable coaxially and integrally with the winding member (3) and another string (S1) having one end fixed to the wound member (30) and wound around the wound member (30), the drive device (10, 10B, 10C, 10D) may pull another string (S1) to rotate the wound member (30) and the winding member (3) in a winding direction of the shade (2), and each of the guide members (6X) may include a string guide portion (64) that extends in the longitudinal direction and slidably supports another string (S1) outside the guide chamber (60, 60a, 60b).

In such a shade apparatus for vehicles, by pulling another string using the drive device to rotate the wound member and the winding member in the winding direction of the shade, the shade can be wound around the winding member and opened. As a result, a biasing mechanism (retractor) that biases the shade in the winding direction can be omitted from the winding member, and the winding member can be reduced in diameter. By adopting the configuration in which another string is pulled to open the shade, the movable range of the shade is not limited due to the restriction of the biasing mechanism. As a result, the shade apparatus for vehicles can be made compact in the height direction to improve the mountability of the shade apparatus for vehicles, and the movable range of the shade can be easily expanded. Furthermore, the overall weight reduction and cost reduction of the apparatus can be achieved by omitting the biasing mechanism. By slidably supporting another string by the string guide portion of the guide member, the shade can be stably and smoothly wound around the winding member or unwound from the winding member based on pulling or unwinding of another string.

Moreover, each of the guide members (6X) may include an inclined surface (65) that extends in the longitudinal direction and is inclined downward as being separated from the opening (600) in the width direction and a wall portion (66) that extends in the longitudinal direction and projects upward from the inclined surface (65), and the string guide portion (64) may be a recess defined by the inclined surface (65) and the wall portion (66).

This makes it possible to successfully prevent another string from swinging in the width direction of the shade when the shade is opened and closed.

The present disclosure is not limited to the above embodiments at all, and it goes without saying that various modifications can be made within the scope of the extension of the present disclosure. Furthermore, the above embodiments are merely specific embodiments as described in “SUMMARY OF INVENTION”, and do not limit the elements of the described in “SUMMARY OF INVENTION”.

### INDUSTRIAL APPLICABILITY

The aspects of the present disclosure can be used in the manufacturing industry for a shade apparatus for vehicles.

1. A shade apparatus for vehicles that is provided on a roof of a vehicle, winds a shade around a winding member, and draws the shade from the winding member, the shade apparatus for vehicles comprising:
paired shoes provided at corresponding side end portions of the shade;
paired guide members extending in a longitudinal direction and each including a guide chamber opened on one side in a width direction;
a string inserted into the guide chamber of each of the guide members and connected to a distal end portion of the shade; and
a drive device that pulls the string to separate the distal end portion of the shade from the winding member, wherein
the side end portion of the shade is folded to an opening side of the guide chamber,
each of the shoes includes an insertion portion to be inserted into a folded side end portion of the shade, and
the folded side end portion of the shade and the insertion portion of each of the shoes are inserted into the guide chamber of each of the guide members and are slidably supported by each of the guide members.

2. The shade apparatus for vehicles according to claim 1, wherein
each of the guide members includes a retaining portion that restricts movement of at least one of the folded side end portion of the shade or the insertion portion of each of the shoes to the opening side.

3. The shade apparatus for vehicles according to claim 2, wherein
the retaining portion is a projection that extends in the longitudinal direction, projects from an upper or lower inner surface of each of the guide members, and faces the lower or upper inner surface of each of the guide members with a space between the retaining portion and the upper or lower inner surface,
the guide chamber is partitioned into a first chamber on an opening side and a second chamber on a closed end side by the projection,
the string is inserted into the second chamber, and
the folded side end portion of the shade and the insertion portion of each of the shoes are inserted into the second chamber.

4. The shade apparatus for vehicles according to claim 1, wherein
the guide chamber is formed so as to gradually decrease in height as being separated from the opening in the width direction.

5. The shade apparatus for vehicles according to claim 1, wherein
each of the guide members includes a string retaining portion that extends in the longitudinal direction and restricts removal of the string from the guide chamber.

6. The shade apparatus for vehicles according to claim 3, wherein
the projection projects from the upper inner surface of each of the guide members and faces the lower inner surface of each of the guide members with a space between the projection and the lower inner surface,
each of the guide members includes a second projection that extends in the longitudinal direction, projects from the lower inner surface of each of the guide members on a closed end side of the projection, and faces the upper inner surface of each of the guide members with a space between the second projection and the upper inner surface,
the side end portion of the shade is supported from below by the second projection, and
the second projection restricts removal of the string from the guide chamber.

7. The shade apparatus for vehicles according to claim 6, wherein
the insertion portion of each of the shoes is curved so as to pass between the projection and the lower inner surface of each of the guide members and pass between the second projection and the upper inner surface of each of the guide members.

8. The shade apparatus for vehicles according to claim 1, wherein each of the guide members includes a shoe retaining portion that engages with a part of each of the shoes to restrict removal of each of the shoes from the guide chamber.

9. The shade apparatus for vehicles according to claim 1, further comprising:
a wound member that is rotatable coaxially and integrally with the winding member; and
another string having one end fixed to the wound member and wound around the wound member, wherein
the drive device pulls another string to rotate the wound member and the winding member in a winding direction of the shade, and
each of the guide members includes a string guide portion that extends in the longitudinal direction and slidably supports another string outside the guide chamber.

10. The shade apparatus for vehicles according to claim 9, wherein
each of the guide members includes an inclined surface that extends in the longitudinal direction and is inclined downward as being separated from the opening in the width direction and a wall portion that extends in the longitudinal direction and projects upward from the inclined surface, and
the string guide portion is a recess defined by the inclined surface and the wall portion.

11. The shade apparatus for vehicles according to claim 2, wherein
the guide chamber is formed so as to gradually decrease in height as being separated from the opening in the width direction.

12. The shade apparatus for vehicles according to claim 3, wherein
the guide chamber is formed so as to gradually decrease in height as being separated from the opening in the width direction.

13. The shade apparatus for vehicles according to claim 2, wherein
each of the guide members includes a string retaining portion that extends in the longitudinal direction and restricts removal of the string from the guide chamber.

14. The shade apparatus for vehicles according to claim 3, wherein
each of the guide members includes a string retaining portion that extends in the longitudinal direction and restricts removal of the string from the guide chamber.

15. The shade apparatus for vehicles according to claim 2, wherein
each of the guide members includes a shoe retaining portion that engages with a part of each of the shoes to restrict removal of each of the shoes from the guide chamber.

16. The shade apparatus for vehicles according to claim 3, wherein
each of the guide members includes a shoe retaining portion that engages with a part of each of the shoes to restrict removal of each of the shoes from the guide chamber.

17. The shade apparatus for vehicles according to claim 2, further comprising:
a wound member that is rotatable coaxially and integrally with the winding member; and
another string having one end fixed to the wound member and wound around the wound member, wherein
the drive device pulls another string to rotate the wound member and the winding member in a winding direction of the shade, and
each of the guide members includes a string guide portion that extends in the longitudinal direction and slidably supports another string outside the guide chamber.

18. The shade apparatus for vehicles according to claim 3, further comprising:
a wound member that is rotatable coaxially and integrally with the winding member; and
another string having one end fixed to the wound member and wound around the wound member, wherein
the drive device pulls another string to rotate the wound member and the winding member in a winding direction of the shade, and
each of the guide members includes a string guide portion that extends in the longitudinal direction and slidably supports another string outside the guide chamber.
